(19) United States
(12) Patent Application Publication
(10) Pub. No.: US 2012/0121913 A1
(43) Pub. Date: May 17, 2012

(54) ADHESIVE COMPOSITION

(75) Inventors: Li-Ming CHANG, Hsinchu City (TW); Meng-Huei CHEN, Gangshan Township (TW); Shur-Fen LIU, Baoshan Township (TW); Jinn-Shing KING, Hsinchu (TW); Yung-Chan LIN, Luzhou City (TW)

(73) Assignee: INDUSTRIAL TECHNOLOGY RESEARCH INSTITUTE, Hsinchu (TW)

(21) Appl. No.: 12/976,612

(22) Filed: Dec. 22, 2010

(30) Foreign Application Priority Data
Nov. 11, 2010 (TW) 099138785

(51) Int. Cl. C09J 163/00; B32B 15/092

(52) U.S. Cl. 428/418; 523/456

(57) ABSTRACT

Disclosed is an adhesive composition including 100 parts by weight of lignin, 150 to 400 parts by weight of epoxy resin, and 7.5 to 200 parts by weight of flexibilizer. The lignin and the flexibilizer can be pre-reacted to enhance the physical properties, e.g. glass transition temperature (Tg) and flexural endurance (MIT), of the cured adhesive composition. Furthermore, the adhesive composition and a flexible metal foil can be laminated to form a flexible substrate.

### CROSS REFERENCE TO RELATED APPLICATIONS

This Application claims priority of Taiwan Patent Application No. 099138785, filed on Nov. 11, 2010, the entirety of which is incorporated by reference herein.

### BACKGROUND OF THE INVENTION

1. Field of the Invention

The present invention relates to adhesive compositions, and in particular relates to flexible printed circuit boards utilizing the same.

2. Description of the Related Art

On Jul. 1, 2006, defined restrictions on the use of certain hazardous substances in electrical and electronic equipment (RoHS) in the European Union became effective. Accordingly, from then, all of the electrical and electronic equipments sold to the EU market, were required to not contain lead, mercury, cadmium, and chromium (VI). Among the types of electrical and electronic equipments, communication components such as printed circuit boards (PCB) faced a dilemma, in meeting the UL94-VO standard requirements of not containing phosphorous and halogen. Also, fine chemical companies also faced a problem of oil running out. Meanwhile, more and more consumers demand reproducible and safe products which are environmentally friendly. Accordingly, more and more products and components which are discarded are trying to meet requirements such as being re-usable, recyclable, and recoverable (3R); thus making the trend for 3R techniques and international trend for the environmentally conscious.

Epoxy resin systems form three-dimensional network structures after being cured; thus, epoxy resin cannot meet 3R requirements. In U.S. Pat. No. 5,833,883 by IBM, biodegradable lignin serves as an epoxy resin curing agent. A glass fabric is impregnated in a formula containing epoxy resin and lignin, and then pre-baked (B-stage) and post-baked (C-stage) to obtain an environmentally friendly FR-4 standard PCB. The green FR-4 standard PCB contains at least 40% of biomass material. In the Journal of Industrial Ecology, 2001, by IBM, the described formula and related processes were disclosed. A product thereof had a glass transition temperature (Tg) of 100° C. to 140° C. The FR-4 board and the copper foils of 1 oz had an adhesive strength of 7.4 lb/in (with CBS copper foil) and 7.1 lb/in (with JTC copper foil), respectively.

In JP2009-292884 by Hitachi Company and Yokohama National University, a lignin was extracted from plants by a phase separation method. The lignin was epoxidized to form an epoxy resin raw material. The lignin which was not epoxidized, served as a curing agent. An imidazole series compound served as a catalyst. The epoxidized lignin, the curing agent, and the catalyst were formulated as a resin formula. A glass fabric having a thickness of 100 μm was impregnated in the resin formula and pre-baked at 130° C. for 8 minutes to obtain six prepregs. The six prepregs were stacked to form a prepreg stack. Two copper foils having a thickness of 35 μm were adhered to both sides of the prepreg stack, and then vacuumed laminated at 200° C. for 1 hour to obtain a copper clad laminated. The prepreg stack had an adhesive strength of 1.4 kN/cm with the copper foils, and a Tg of 230° C. (measured by dynamic mechanical analysis, DMA).

In JP2008-138061 by the Meiden Company, an epoxidized linseed oil was mixed with a lignin (served as a curing agent). The mixture was heated and cured with a curing agent (e.g. 2-methyl-4-imidzole) at 150° C. to 170° C. for 10 to 20 hours, thereby, obtaining an insulating polymer composition having a Tg of 85° C. to 100° C. The insulating polymer composition had a folding strength of 135 to 145 MPa at room temperature.

In January 2010, Yokohama National University published a paper titled “Study on Lignophenol-Cured Epoxy Resin” in Network polymer. An epoxy resin (DGEBA), a curing agent (lignin), and a catalyst (1-cyanoethyl-2-ethyl-4-methylimidazole, 2E4MZ-CN) were mixed. The mixture was baked at 60° C. to remove solvent thereof, and cured at 110° C. for 0.5 hours, 150° C. for 2 hours, and 180° C. for 3 hours, thereby obtaining a plate material. The plate material contained 38% to 48% of biomass material. The plate material had a Tg of 198° C. and a folding strength of 134 MPa.

In the Journal of Applied Polymer Science, Vol. 105, page 2332-2338, 2007, ShangHai Jiaotong University published a paper titled “DSC Study on the Effect of Cure Reagents on the Lignin Base Epoxy Cure Reaction”. Liquid lignin base epoxy resin (LEPL) was collocated with different types of curing agents, such as methylhexahydrophthalic anhydride (MTHPA), maleic anhydride (MA), and 2-methyl-4-methylimidazole (EMI-2,4). The reaction kinetics of the mixtures was discussed with the DSC and FTIR data. The activation energies (E), frequencies (ln A), and orders of the reactions between the LEPL and the three curing agents were calculated by the Kissinger method. The LEPL-MTHPA reaction had an active energy of 76.54 kJ/mol, the LEPL-MA reaction had an active energy of 56.35 kJ/mol, and the LEPL-EMI-2,4 reaction had an active energy of 47.22 kJ/mol. The LEPL-MTHPA reaction had a frequency (ln A) of 25.3, the LEPL-MA reaction had an frequency (ln A) of 19.6, and the LEPL-EMI-2,4 reaction had an frequency (ln A) of 16.58. The reaction dynamic equations of the three reactions were deducted from the activation energies, the frequencies, and the orders of the three reactions. Referring to the FTIR spectra of the three reactions, all of the three curing agents may cure the LEPL.

The cured epoxy resin formulae in the related art mentioned above, were all applied to hard plates rather than biomass and flexible PCBs. Accordingly, the formulae should be tuned for application in flexible PCBs, so that modified formulae may meet 3R requirements.

### BRIEF SUMMARY OF THE INVENTION

One embodiment of the invention provides an adhesive composition, comprising: 100 parts by weight of lignin; 150 to 1400 parts by weight of epoxy resin; and 7.5 to 200 parts by weight of flexibilizer.

A detailed description is given in the following embodiments with reference to the accompanying drawings.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In one embodiment, the lignin in plants such as rice husk or timber is extracted according to the methods disclosed by KADLA in J. Agric. Food Chem. 2006, 54, 5806-5813 and the likes. Lignin, has a weight-average molecular weight of 500 to 2000. Using a lignin with an overly low weight-average molecular weight lowers the Tg of a cured adhesive composition, and a lignin with an overly high weight-average molecular weight degrades flexibility of a cured adhesive composition. A lignin, has randomly arranged hydroxyl groups, phenolic hydroxyl groups, and ether groups. The conventional curing agent (e.g. the phenolic resin), of the epoxy resin, can be replaced by the phenolic hydroxyl groups of the lignin. Compared to the conventional adhesive composition of flexible epoxy resins, the adhesive composition of the flexible epoxy resin cured by lignin has a higher Tg (>150%), better flexibility, and lower cost.

In one embodiment, the adhesive composition includes 100 parts by weight of lignin, 150 to 400 parts by weight of epoxy resin, and 7.5 to 200 parts by weight of a flexibilizer. An overly high ratio of epoxy resin lowers flexibility of a cured adhesive composition, and an overly low ratio of epoxy resin lowers thermal resistance of a cured adhesive composition. Also, an overly high ratio of a flexibilizer lowers thermal resistance of a cured adhesive composition, and an overly low ratio of a flexibilizer lowers flexibility of a cured adhesive composition. The flexibilizer can be carboxyl-terminated polybutadiene acrylonitrile (CTBN), hydroxyl-terminated polybutadiene acrylonitrile (HTBN), epoxy-terminated polybutadiene acrylonitrile (ETBN), amino-terminated polybutadiene acrylonitrile (ATBN), styrene-butadiene-styrene copolymer (SBS), styrene-ester-butadiene-styrene copolymer (SEBS), polyamide, polyamideimide, polyacrylate, or combinations thereof. The flexibilizer has a weight-average molecular weight of 1000 to 150000. A flexibilizer with an overly high weight-average molecular weight lowers flexibility of a cured adhesive composition, and a flexibilizer with an overly high weight-average molecular weight lowers thermal resistance of a cured adhesive composition.

In another embodiment, the adhesive composition may further include 40 parts by weight or less of a catalyst. The catalyst can increase Tg and flexibility of a cured adhesive composition. However, an overly high ratio of the catalyst lowers flexibility of a cured adhesive composition. The catalyst can be of an imidazole series, such as 2-methylimidazole (2MZ), 1-cyanoethyl-2-methylimidazole (2MZ-CN), 2-ethyl-4-methylimidazole (2E4MZ), 1-cyanoethyl-2-ethyl-4-methylimidazole (2E4MZ-CN), 2-phenylimidazole (2PZ), 1-cyanoethyl-2-phenylimidazole (2PZ-CN), or combinations thereof.

In one embodiment, the lignin can pre-react with the flexibilizer, such that both are bonded together to form a modified lignin. The pre-reaction method can be an esterification method. The flexibilizer modified lignin is subsequently mixed with an epoxy resin to make a cured adhesive composition having high Tg and flexibility.

The petroleum based curing agent is replaced by the lignin, a biomass material. The lignin is introduced in the epoxy resin formula for a ring-opening crosslink reaction. The epoxy resin formula containing lignin can be coated on an insulating film, pre-baked, laminated with metal foils, and completely cured, thereby obtaining an environmentally friendly, flexible, and laminated metal substrate containing the biomass material. The environmentally friendly, flexible, and laminated metal substrate has a Tg greater than 150° C., a better flexibility, and an adhesive strength greater than 5 lb/in.

### Example

### Manufacturing a Flexible and Laminated PCB

Epoxy resin formula was coated on a polyimide film (NPI, commercially available from Kaneka) having a thickness of 25 μm. The coating was pre-baked at 120° C. for 15 minutes (B-stage) to remove solvent thereof, thereby obtaining an adhesive layer having a thickness of 18 μm. ED copper foil (F2-WS, commercially available from FCFTawian company) was adhered to the adhesive layer at 100° C., and post-baked at 110° C. for 20 minutes, 130° C. for 30 minutes, 150° C. for 30 minutes, 180° C. for 4 hours, and 220° C. for 1 hour (or 220° C. for 1.75 hours) (C-stage) to obtain a three-layered, flexible copper clad laminate (FCCL).

Analysis of Properties:

Analysis of Glass Transition Temperature (Tg)

A cured resin film having a thickness of 18 μm was thermomechanically analyzed by Q-400 (commercially available from TA), with a rising temperature rate of 10° C./min. Tg of the cured resin film is the crossing point of the linear status tangent line and the softening status tangent line of the thermo mechanical analysis result.

Copper Foil Peeling Strength

The copper foil peeling strength of the flexible copper clad laminate was measured according to the IPC-TM-650 (2.4.9) testing method.

Flexural Endurance

The folding times (MIT test), of the flexible copper clad laminate, was measured according to the JIS-C-6471 testing method (R=0.8 mm, load=0.5 kg), wherein the line width of the flexible copper clad laminate was 1.5 mm.

Reagents:

The lignin used in Examples and Comparative Examples was prepared according to the method disclosed by KADLA in J. Agric. Food Chem. 2006, 54, 5806-5813.

The flexibilizer used in Examples 1-6, 13-15, and 22-24, and Comparative Example 1-3 was CTBN (Hycar® 1072-CG, commercially available from B. F. Goodrich Chemical Co.). The flexibilizer used in Examples 7-12 and 16-21, and Comparative Example 4 was CTBN (Hycar® 1300*13, commercially available from B. F. Goodrich Chemical Co.). The flexibilizer used in Example 25 was HTBN (commercially available from Zibo Qilong Chemical Industry Co. Ltd.). The flexibilizer used in Example 26 was ETBN (CHX100, commercially available from Devote Chemical Industry Co. Ltd., China). The flexibilizer used in Example 27 was ATBN commercially available from B. F. Goodrich Chemical Co. The flexibilizer used in Example 28 was SBS (Kraton® D1116 E, commercially available from Kraton Performance Polymers Inc.). The flexibilizer used in Example 29 was SEBS (Kraton® G1633E, commercially available from Kraton Performance Polymers Inc.). The flexibilizer used in Example 30 was polyamide (KINGMIDE 300, commercially available from Sanho Chemical Co., Ltd.). The flexibilizer used in Example 31 was polyamideimide (TORLON® 4203, commercially available from Modern Plastic Inc.). The flexibilizer used in Example 32 was polyacrylate (ELVACITE® 20444, commercially available from Lucite International, Inc.).

The epoxy resin used in the Examples and Comparative Examples was EPON™ 828 commercially available from Shell Company.

The catalyst used in the Examples and Comparative Examples was 1-cyanoethyl-2-ethyl-4-methylimidazole (2E4MZ-CN) commercially available from Aldrich.

Preparation 1 (Pre-Reaction of Lignin and Flexibilizer CTBN)

95 g of lignin and 5 g of a flexibilizer CTBN (Hycar® 1300*13) were weighted and then dissolved in a GBL solvent, respectively. The lignin solution was charged in a three-necked reaction bottle, added 0.5 wt % of a catalyst triphenylphosphine (TPP), and then heated to 110° C. The CTBN solution was added to the reaction bottle containing the heated lignin solution to perform a pre-reaction for 3 hours. Thereafter, a flexibilizer modified lignin solution having a solid content of 25% was obtained.

Preparation 2 (Pre-Reaction of Lignin and Flexibilizer CTBN)

90 g of lignin and 10 g of a flexibilizer CTBN (Hycar® 1300*13) were weighted and then dissolved in a GBL solvent, respectively. The lignin solution was charged in a three-necked reaction bottle, added 0.5 wt % of a catalyst triphenylphosphine (TPP), and then heated to 110° C. The CTBN solution was added to the reaction bottle containing the heated lignin solution to perform a pre-reaction for 3 hours. Thereafter, a flexibilizer modified lignin solution having a solid content of 25% was obtained.

### Example 1

70 g of the epoxy resin, 37.7 g of the lignin solution (solid content of 25% in GBL), 21 g of the flexibilizer CTBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 165° C., folding times of 225 times, and a peeling strength (of the copper foil) greater than 5.5 lb/in.

### Example 2

70 g of the epoxy resin, 37.7 g of the flexibilizer modified lignin solution in Preparation 1 (solid content of 25% in GBL), 21 g of the flexibilizer CTBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 167° C., folding times of 236 times, and a peeling strength (of the copper foil) greater than 5.5 lb/in. Compared to Example 1, the formula in Example 2 containing the lignin pre-modified by the flexibilizer may increase Tg and flexibility of the cured adhesive composition.

### Example 3

70 g of the epoxy resin, 37.7 g of the flexibilizer modified lignin solution in Preparation 2 (solid content of 25% in GBL), 21 g of the flexibilizer CTBN solution (solid content of 20% in GBL), and 0.7 g of a catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 170° C., folding times of 245 times, and a peeling strength (of the copper foil) greater than 5.5 lb/in. Compared to Example 2, the formula in Example 3 containing the lignin pre-modified by more flexibilizer than in Preparation 2 may increase Tg and flexibility of the cured adhesive composition.

### Example 4

70 g of epoxy resin, 37.7 g of flexibilizer modified lignin solution in Preparation 1 (solid content of 25% in GBL), and 21 g of a flexibilizer CTBN solution (solid content of 20% in GBL) were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1.75 hours (C-Stage) to obtain a three-layered, flexible, and copper clad laminate. The adhesive layer of the product had a Tg of 163° C., folding times of 228 times, and a peeling strength (of the copper foil) greater than 5.5 lb/in. Compared to Example 2, the formula in Example 4 without the catalyst needed a longer post-baking period, and Tg and flexibility of the cured adhesive composition was decreased.

### Example 5

70 g of the epoxy resin, 37.7 g of the flexibilizer modified lignin solution in Preparation 2 (solid content of 25% in GBL), and 21 g of the flexibilizer CTBN solution (solid content of 20% in GBL) were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1.75 hours (C-Stage) to obtain a three-layered, flexible, and copper clad laminate. The adhesive layer of the product had a Tg of 165° C., folding times of 239 times, and a peeling strength (of the copper foil) greater than 5.5 lb/in. Compared to Example 3, the formula in Example 5 without the catalyst needed a longer post-baking period, and Tg and flexibility of the cured adhesive composition was decreased. Compared to Example 4, the formula in Example 5 containing the lignin pre-modified by more flexibilizer than in Preparation 2 may increase Tg and flexibility of the cured adhesive composition.

### Example 6

70 g of the epoxy resin, 37.7 g of the lignin solution (solid content of 25% in GBL), and 21 g of the flexibilizer CTBN solution (solid content of 20% in GBL) were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1.75 hours (C-Stage) to obtain a three-layered, flexible, and copper clad laminate. The adhesive layer of the product had a Tg of 158° C., folding times of 241 times, and a peeling strength (of the copper foil) greater than 5.5 lb/in.

### Example 7

70 g of the epoxy resin, 37.7 g of the lignin solution (solid content of 25% in GBL), 21 g of the flexibilizer CTBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and laminated printed circuit board. The adhesive layer of the product had a Tg of 170° C., folding times of 185 times, and a peeling strength (of the copper foils) greater than 5.2 lb/in. Compared to the formula containing the flexibilizer 1072-CG in Example 1, the formula containing flexibilizer 1300*13, increased Tg, decreased flexibility, and decreased copper foil peeling strength of the cured adhesive composition in Example 7.

### Example 8

70 g of the epoxy resin, 37.7 g of the flexibilizer modified lignin solution in Preparation 1 (solid content of 25% in GBL), 21 g of the flexibilizer CTBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 172° C., folding times of 189 times, and a peeling strength (of the copper foil) greater than 5.2 lb/in. Compared to Example 7, the formula in Example 8 containing the lignin pre-modified by the flexibilizer may increase Tg and flexibility of the cured adhesive composition.

### Example 9

70 g of the epoxy resin, 37.7 g of the flexibilizer modified lignin solution in Preparation 2 (solid content of 25% in GBL), 21 g of the flexibilizer CTBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 175° C., folding times of 195 times, and a peeling strength (of the copper foil) greater than 5.2 lb/in. Compared to Example 8, the formula in Example 9 containing the lignin pre-modified by more flexibilizer than in Preparation 2 may increase Tg and flexibility of the cured adhesive composition.

### Example 10

70 g of the epoxy resin, 37.7 g of the lignin solution (solid content of 25% in GBL), and 21 g of the flexibilizer CTBN solution (solid content of 20% in GBL) were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1.75 hours (C-Stage) to obtain a three-layered, flexible, and copper clad laminate. The adhesive layer of the product had a Tg of 164° C., folding times of 190 times, and a peeling strength (of the copper foil) greater than 5 lb/in. Compared to Example 9, the formula without the catalyst in Example 10 needed a longer post-baking period. Compared to Example 9, the formula without the catalyst in Example 10 may decrease Tg and increase flexibility of the cured adhesive composition.

### Example 11

70 g of the epoxy resin, 37.7 g of the flexibilizer modified lignin solution in Preparation 1 (solid content of 25% in GBL), and 21 g of the flexibilizer CTBN solution (solid content of 20% in GBL) were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1.75 hours (C-Stage) to obtain a three-layered, flexible, and copper clad laminate. The adhesive layer of the product had a Tg of 167° C., folding times of 193 times, and a peeling strength (of the copper foil) greater than 5 lb/in. Compared to Example 10, the formula in Example 11 containing the lignin pre-modified by the flexibilizer may increase Tg and flexibility of the cured adhesive composition.

### Example 12

70 g of the epoxy resin, 37.7 g of the flexibilizer modified lignin solution in Preparation 2 (solid content of 25% in GBL), and 21 g of the flexibilizer CTBN solution (solid content of 20% in GBL) were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1.75 hours (C-Stage) to obtain a three-layered, flexible, and laminated printed circuit board. The adhesive layer of the product had a Tg of 169° C., folding times of 199 times, and a peeling strength (of the copper foil) greater than 5 lb/in. Compared to Example 9, the formula in Example 12 without the catalyst needed a longer post-baking period. Compared to Example 9, the formula without the catalyst in Example 12 may decrease Tg and increase flexibility of the cured adhesive composition.

### Example 13

70 g of the epoxy resin, 46.7 g of the flexibilizer modified lignin solution in Preparation 2 (solid content of 25% in GBL), and 21 g of the flexibilizer CTBN solution (solid content of 20% in GBL) were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1.75 hours (C-Stage) to obtain a three-layered, flexible, and copper clad laminate. The adhesive layer of the product had a Tg of 170° C., folding times of 229 times, and a peeling strength (of the copper foil) greater than 5 lb/in. Compared to the formula containing the flexibilizer 1300*13 in Example 12, the formula containing the flexibilizer 1072-CG in Example 13, increased flexibility of the cured adhesive composition.

### Example 14

70 g of the epoxy resin, 46.7 g of the lignin solution (solid content of 25% in GBL), and 21 g of the flexibilizer CTBN solution (solid content of 20% in GBL) were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1.75 hours (C-Stage) to obtain a three-layered, flexible, and copper clad laminate. The adhesive layer of the product had a Tg of 165° C., folding times of 217 times, and a peeling strength (of the copper foil) greater than 5 lb/in. Compared to Example 13, the formula in Example 14 containing the lignin not pre-modified by the flexibilizer may decrease Tg and flexibility of the cured adhesive composition.

### Example 15

70 g of the epoxy resin, 46.7 g of the flexibilizer modified lignin solution in Preparation 1 (solid content of 25% in GBL), and 21 g of the flexibilizer CTBN solution (solid content of 20% in GBL) were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1.75 hours (C-Stage) to obtain a three-layered, flexible, and copper clad laminate. The adhesive layer of the product had a Tg of 168° C., folding times of 225 times, and a peeling strength (of the copper foils) greater than 5 lb/in. Compared to Example 14, the formula in Example 15 containing the lignin pre-modified by the flexibilizer may increase Tg and flexibility of the cured adhesive composition.

### Example 16

70 g of the epoxy resin, 46.7 g of the lignin solution (solid content of 25% in GBL), 21 g of the flexibilizer CTBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 182° C., folding times of 203 times, and a peeling strength (of the copper foil) greater than 5 lb/in. Compared to Example 7, the formula in Example 16 containing more lignin may increase Tg and flexibility of the cured adhesive composition, but decrease the copper foil peeling strength of cured adhesive composition. Compared to Example 10, the formula in Example 16 containing the catalyst may decrease the post-baking period and increase Tg and flexibility of the cured adhesive composition.

### Example 17

70 g of the epoxy resin, 46.7 g of the flexibilizer modified lignin solution in Preparation 1 (solid content of 25% in GBL), 21 g of the flexibilizer CTBN solution (solid content of 20% in GBL), and the 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and two copper foils having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and laminated printed circuit board. The adhesive layer of the product had a Tg of 184° C., folding times of 208 times, and a peeling strength (of the copper foils) greater than 5 lb/in. Compared to Example 11, the formula in Example 17 containing the catalyst may decrease the post-baking period and increase Tg and flexibility of the cured adhesive composition. Compared to Example 16, the formula in Example 17 containing a lignin pre-modified by the flexibilizer may increase Tg and flexibility of the cured adhesive composition.

### Example 18

70 g of the epoxy resin, 46.7 g of the flexibilizer modified lignin solution in Preparation 2 (solid content of 25% in GBL), 21 g of the flexibilizer CTBN solution (solid content of 20% in GBL), and the 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 186° C., folding times of 214 times, and a peeling strength (of the copper foil) greater than 5 lb/in. Compared to Example 12, the formula in Example 18 containing the catalyst may decrease the post-baking period and increase Tg and flexibility of the cured adhesive composition. Compared to Example 17, the formula in Example 18 containing the lignin pre-modified by more flexibilizer than in Preparation 2 may increase Tg and flexibility of the cured adhesive composition.

### Example 19

70 g of the epoxy resin, 46.7 g of the lignin solution (solid content of 25% in GBL), and 21 g of the flexibilizer CTBN solution (solid content of 20% in GBL) were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1.75 hours (C-Stage) to obtain a three-layered, flexible, and copper clad laminate. The adhesive layer of the product had a Tg of 171° C., folding times of 190 times, and a peeling strength (of the copper foil) greater than 5 lb/in. Compared to Example 16, the formula in Example 19 without the catalyst needed a longer post-baking period. Compared to Example 16, the formula without the catalyst in Example 19 may decrease Tg and flexibility of the cured adhesive composition.

### Example 20

70 g of the epoxy resin, 46.7 g of the flexibilizer modified lignin solution in Preparation 1 (solid content of 25% in GBL), and 21 g of the flexibilizer CTBN solution (solid content of 20% in GBL) were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1.75 hours (C-Stage) to obtain a three-layered, flexible, and copper clad laminate. The adhesive layer of the product had a Tg of 172° C., folding times of 192 times, and a peeling strength (of the copper foil) greater than 5 lb/in. Compared to Example 19, the formula in Example 20 containing the lignin pre-modified by the flexibilizer may increase Tg and flexibility of the cured adhesive composition.

### Example 21

70 g of the epoxy resin, 46.7 g of the flexibilizer modified lignin solution in Preparation 2 (solid content of 25% in GBL), and 21 g of the flexibilizer CTBN solution (solid content of 20% in GBL) were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1.75 hours (C-Stage) to obtain a three-layered, flexible, and copper clad laminate. The adhesive layer of the product had a Tg of 175° C., folding times of 199 times, and a peeling strength (of the copper foil) greater than 5 lb/in. Compared to Example 20, the formula in Example 21 containing the lignin pre-modified by more flexibilizer than in Preparation 2 may increase Tg and flexibility of the cured adhesive composition.

### Example 22

70 g of the epoxy resin, 46.7 g of the flexibilizer modified lignin solution in Preparation 2 (solid content of 25% in GBL), 21 g of the flexibilizer CTBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 185° C., folding times of 220 times, and a peeling strength (of the copper foil) greater than 5 lb/in. Compared to Example 14, the formula in Example 22 containing the catalyst may decrease the post-baking period and increase Tg and flexibility of the cured adhesive composition.

### Example 23

70 g of the epoxy resin, 46.7 g of the lignin solution (solid content of 25% in GBL), 21 g of the flexibilizer CTBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 180° C., folding times of 210 times, and a peeling strength (of the copper foil) greater than 5 lb/in. Compared to Example 22, the formula in Example 23 containing the lignin not pre-modified by the flexibilizer may decrease Tg and flexibility of the cured adhesive composition.

### Example 24

70 g of the epoxy resin, 46.7 g of the flexibilizer modified lignin solution in Preparation 1 (solid content of 25% in GBL), 21 g of the flexibilizer CTBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 182° C., folding times of 215 times, and a peeling strength (of the copper foil) greater than 5 lb/in. Compared to Example 23, the formula in Example 24 containing the lignin pre-modified by the flexibilizer may increase Tg and flexibility of the cured adhesive composition.

### Example 25

70 g of the epoxy resin, 46.7 g of the lignin solution (solid content of 25% in GBL), 21 g of the flexibilizer HTBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 174° C., folding times of 155 times, and a peeling strength (of the copper foil) greater than 4 lb/in.

### Example 26

70 g of the epoxy resin, 46.7 g of the lignin solution (solid content of 25% in GBL), 21 g of the flexibilizer ETBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 175° C., folding times of 160 times, and a peeling strength (of the copper foil) greater than 4 lb/in.

### Example 27

70 g of the epoxy resin, 46.7 g of the lignin solution (solid content of 25% in GBL), 21 g of the flexibilizer ATBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 176° C., folding times of 170 times, and a peeling strength (of the copper foil) greater than 4 lb/in.

### Example 28

70 g of the epoxy resin, 46.7 g of the lignin solution (solid content of 25% in GBL), 21 g of the flexibilizer SBS solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 100° C. and 197° C., folding times of 90 times, and a peeling strength (of the copper foil) greater than 3 lb/in.

### Example 29

70 g of the epoxy resin, 46.7 g of the lignin solution (solid content of 25% in GBL), 21 g of the flexibilizer SEBS solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 120° C. and 195° C., folding times of 80 times, and a peeling strength (of the copper foil) greater than 3 lb/in.

### Example 30

70 g of the epoxy resin, 46.7 g of the lignin solution (solid content of 25% in GBL), 21 g of the flexibilizer polyamide solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 185° C., folding times of 150 times, and a peeling strength (of the copper foil) greater than 5 lb/in.

### Example 31

70 g of the epoxy resin, 46.7 g of the lignin solution (solid content of 25% in GBL), 21 g of the flexibilizer polyamideimide solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 187° C., folding times of 130 times, and a peeling strength (of the copper foil) greater than 3.7 lb/in.

### Example 32

70 g of the epoxy resin, 46.7 g of the lignin solution (solid content of 25% in GBL), 21 g of the flexibilizer polyacrylate solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 175° C., folding times of 110 times, and a peeling strength (of the copper foil) greater than 4 lb/in.

### Comparative Example 1

70 g of the epoxy resin, 7.8 g of the lignin solution (solid content of 25% in GBL), 21 g of the flexibilizer CTBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, 180° C. for 4 hours, and 220° C. for 1 hour (C-Stage) to obtain a three-layered, flexible, and copper clad laminate. The adhesive layer of the product had a Tg of 90° C., folding times of 125 times, and a peeling strength (of the copper foil) greater than 2 lb/in. Compared to Example 1, the formula in Comparative Example 1 containing an overly low amount of the lignin may dramatically decrease Tg, flexibility, and copper foil peeling strength of the cured adhesive composition.

### Comparative Example 2

70 g of the epoxy resin, 70 g of the lignin solution (solid content of 25% in GBL), 21 g of the flexibilizer CTBN solution (solid content of 20% in GBL), and 0.7 g of the catalyst 2E4MZ-CN were mixed, but, the lignin was precipitated. As such, the mixture could not be coated on the NPI film. Compared to Example 1, the formula containing an overly high amount of the lignin could not serve as an adhesive composition.

### Comparative Example 3

70 g of the epoxy resin, 143.5 g of the 4-methylcyclohexane-1,2-dicarboxylic anhydride, 60 g of the flexibilizer CTBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, and 180° C. for 4 hours (C-Stage) to obtain a three-layered, flexible, and copper clad laminate. The adhesive layer of the product had a Tg of 85° C., folding times of 205 times, and a peeling strength (of the copper foil) greater than 5 lb/in. Compared to the formula containing the lignin in Example 1, the formula containing 4-methylcyclohexane-1,2-dicarboxylic anhydride in Comparative Example 3 may dramatically decrease Tg of the cured adhesive composition.

### Comparative Example 4

70 g of the epoxy resin, 143.5 g of the 4-methylcyclohexane-1,2-dicarboxylic anhydride, 60 g of the flexibilizer CTBN solution (solid content of 20% in GBL), and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, and 180° C. for 4 hours (C-Stage) to obtain a three-layered, flexible, and copper clad laminate. The adhesive layer of the product had a Tg of 96° C., folding times of 190 times, and a peeling strength (of the copper foil) greater than 4.7 lb/in. Compared to the formula containing the lignin in Example 16, the formula containing 4-methylcyclohexane-1,2-dicarboxylic anhydride in Comparative Example 4 may dramatically decrease Tg of the cured adhesive composition.

### Comparative Example 5

70 g of the epoxy resin, 143.5 g of the 4-methylcyclohexane-1,2-dicarboxylic anhydride, and 0.7 g of the catalyst 2E4MZ-CN were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, and 180° C. for 4 hours (C-Stage) to obtain a three-layered, flexible, and copper clad laminate. The adhesive layer of the product had a Tg of 165° C., folding times of 10 times, and a peeling strength (of the copper foil) greater than 4.5 lb/in. Compared to Comparative Example 4, the formula without the flexibilizer in Comparative Example 5 may increase Tg and dramatically decrease flexibility of the cured adhesive composition.

### Comparative Example 6

70 g of the epoxy resin and 143.5 g of the 4-methylcyclohexane-1,2-dicarboxylic anhydride were evenly mixed. The mixture was uniformly coated on an NPI film having a thickness of 25 μm. The coating was pre-baked at 120° C. for 15 minutes (B-stage) to remove solvent and obtain an adhesive composition having a thickness of 18 μm. Thereafter, the adhesive composition and copper foil having a thickness of 18 μm were laminated at 100° C., and then post-baked at 110° C. for 20 minutes, 130° C. for 30 minutes, 150° C. for 30 minutes, and 180° C. for 4 hours (C-Stage) to obtain a three-layered, flexible, and copper clad laminate. The adhesive layer of the product had a Tg of 140° C., folding times of 12 times, and a peeling strength (of the copper foil) greater than 4.2 lb/in. Compared to Comparative Example 5, the formula without the catalyst in Comparative Example 6 may further decrease Tg of the cured adhesive composition.

As shown in the comparison between Examples 1-32 and Comparative Example 1-6, appropriate amount of the lignin may simultaneously enhance Tg and flexibility of the cured adhesive composition. Data of Tg, flexibility, and copper foil peeling strength of the cured adhesive compositions are tabulated in Table 1.

TABLE 1

| | | Folding | Peeling strength |
|---|---|---|---|
| Example No. | Tg (° C.) | times (MIT) | (lb/in) |
| Example 1 | 165 | 225 | >5.5 |
| Example 2 | 167 | 236 | >5.5 |
| Example 3 | 170 | 245 | >5.5 |
| Example 4 | 163 | 228 | >5.5 |
| Example 5 | 165 | 239 | >5.5 |
| Example 6 | 158 | 241 | >5.5 |
| Example 7 | 170 | 185 | >5.2 |
| Example 8 | 172 | 189 | >5.2 |
| Example 9 | 175 | 195 | >5.2 |
| Example 10 | 164 | 190 | >5.0 |
| Example 11 | 167 | 193 | >5.0 |
| Example 12 | 169 | 199 | >5.0 |
| Example 13 | 170 | 229 | >5.0 |
| Example 14 | 165 | 217 | >5.0 |
| Example 15 | 168 | 225 | >5.0 |
| Example 16 | 182 | 203 | >5.0 |
| Example 17 | 184 | 208 | >5.0 |
| Example 18 | 186 | 214 | >5.0 |
| Example 19 | 171 | 190 | >5.0 |
| Example 20 | 172 | 192 | >5.0 |
| Example 21 | 175 | 199 | >5.0 |
| Example 22 | 185 | 220 | >5.0 |
| Example 23 | 180 | 210 | >5.0 |
| Example 24 | 182 | 215 | >5.0 |
| Example 25 | 174 | 155 | >4.0 |
| Example 26 | 175 | 160 | >4.0 |
| Example 27 | 176 | 170 | >4.0 |
| Example 28 | 100, 197 | 90 | >3.0 |
| Example 29 | 120, 195 | 80 | >3.0 |
| Example 30 | 185 | 150 | >5.0 |
| Example 31 | 187 | 130 | >3.7 |
| Example 32 | 175 | 110 | >4.0 |
| Comparative | 90 | 125 | >2 |
| example 1 | | | |
| Comparative | x | x | x |
| Example 2 | | | |
| Comparative | 85 | 205 | >5 |
| Example 3 | | | |
| Comparative | 96 | 190 | >4.7 |
| Example 4 | | | |
| Comparative | 165 | 10 | >4.5 |
| Example 5 | | | |
| Comparative | 140 | 12 | >4.2 |
| Example 6 | | | |

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An adhesive composition, comprising:
100 parts by weight of lignin;
150 to 1400 parts by weight of epoxy resin; and
7.5 to 200 parts by weight of flexibilizer.

2. The adhesive composition as claimed in claim 1, wherein the lignin has a weight-average molecular weight of 500 to 2000.

3. The adhesive composition as claimed in claim 1, wherein the flexibilizer comprises carboxyl-terminated polybutadiene acrylonitrile, hydroxyl-terminated polybutadiene acrylonitrile, epoxy-terminated polybutadiene acrylonitrile, amino-terminated polybutadiene acrylonitrile, styrene-butadiene-styrene copolymer, styrene-ester-butadiene-styrene copolymer, polyamide, polyamideimide, polyacrylate, or combinations thereof.

4. The adhesive composition as claimed in claim 1, wherein the flexibilizer has a weight-average molecular weight of 1000 to 150000.

5. The adhesive composition as claimed in claim 1, further comprising 40 parts by weight or less of catalyst.

6. The adhesive composition as claimed in claim 5, wherein the catalyst comprises 2-methylimidazole, 1-cyanoethyl-2-methylimidazole, 2-ethyl-4-methylimidazole, 1-cyanoethyl-2-ethyl-4-methylimidazole, 2-phenylimidazole, 1-cyanoethyl-2-phenylimidazole, or combinations thereof.

7. The adhesive composition as claimed in claim 1, wherein the lignin and the flexibilizer are pre-reacted to form a modified lignin.

8. The adhesive composition as claimed in claim 1, laminated with a flexible metal foil for manufacturing a flexible substrate.
